(19) United States
(12) Patent Application Publication
(10) Pub. No.: US 2026/0172183 A1
(43) Pub. Date: Jun. 18, 2026

(54) Device, entity, signals, and methods for a wireless communication network for using a model with different configurations

(71) Applicant: Fraunhofer-Gesellschaft zur Förderung der angewandten Forschung e.V., München (DE)

(72) Inventors: Tatiana RYKOV, Berlin (DE); Thomas FEHRENBACH, Berlin (DE); Baris GÖKTEPE, Berlin (DE); Thomas WIRTH, Berlin (DE); Thomas SCHIERL, Berlin (DE); Cornelius HELLGE, Berlin (DE); Thomas WIEGAND, Berlin (DE)

(21) Appl. No.: 19/536,558

(22) Filed: Feb. 11, 2026

Related U.S. Application Data
(63) Continuation of application No. PCT/EP2024/073209, filed on Aug. 19, 2024.

(30) Foreign Application Priority Data
Aug. 17, 2023 (EP) 23191998.6

(51) Int. Cl. H04L 5/00; H04N 19/61

(52) U.S. Cl. CPC H04L 5/0048; H04N 19/61

(57) ABSTRACT

Embodiments according to the invention comprise a device for operating in a wireless communication network. The device is to operate a model to estimate (and/or optionally to model) and/or to predict one or more parameters and/or a characteristics of the wireless communication network. Furthermore, corresponding entities, signals and methods are disclosed.

### CROSS-REFERENCES TO RELATED APPLICATIONS

This application is a continuation of copending International Application No. PCT/EP2024/073209, filed Aug. 19, 2024, which is incorporated herein by reference in its entirety, and additionally claims priority from European Application No. EP 23 191 998.6, filed Aug. 17, 2023, which is incorporated herein by reference in its entirety.

### BACKGROUND OF THE INVENTION

Embodiments according to the invention comprise devices, entities, signals and methods for a wireless communication network for using a model with different configurations.

Embodiments of the present application relate to the field of wireless communication, and more specifically, to wireless communication between a user equipment, UE, and a base station, BS. Some embodiments relate to Channel State Information (CSI) feedback quantization.

FIGS. 1a and 1b comprise a schematic representation of an example of a terrestrial wireless network 100 including, as is shown in FIG. 1(a), a core network 102 and one or more radio access networks RAN₁, RAN₂, . . . . RAN_{N}. FIG. 1(b) is a schematic representation of an example of a radio access network RANₙ that may include one or more base stations gNB1 to gNB5, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB2. Another user UE₃ is shown in cell 106₄ which is served by base station gNB4. The arrows 108₁, 108₂ and 108₃ schematically represent uplink/downlink connections for transmitting data from a user UE₁, UE₂ and UE₃ to the base stations gNB2, gNB4 or for transmitting data from the base stations gNB2, gNB4 to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB4 to receive and transmit data as schematically represented by arrow 112₁. The IoT device 110₂ accesses the wireless communication system via the user UE₃ as is schematically represented by arrow 112₂. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may be a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

It is noted that the information in the above section is only for enhancing the understanding of the background of the invention and therefore it may contain information that does not form conventional technology and may hence contain information that is not already known to a person of ordinary skill in the art.

Furthermore, an important aspect of an operation of a wireless communication network, e.g. as outlined by the above-discussion of FIGS. 1 to 5, is the provision of characteristics, such as channel state information, CSI, in addition to achieving an efficient transmission thereof, e.g. to allow for an adaptation of the network with regard to the characteristic. However, conventional approaches are not able to exploit the full scope of possible optimization.

Therefore, there is a need for enhancing operation of a wireless communication network. In particular, it is desired to get a concept which makes a better compromise between computational costs, a use of transmission resources, a complexity and a robustness of the operation of the wireless communication network.

### SUMMARY

An embodiment may have a device for operating in a wireless communication network, wherein the device is to operate a model to estimate and/or to predict one or more parameters and/or a characteristics of the wireless communication network.

Another embodiment may have an entity for operating in a wireless communication network, wherein the entity is to control operation of a model at a device in the wireless communication network, the model adapted to estimate and/or to predict one or more parameters and/or a characteristics of the wireless communication network.

Another embodiment may have a non-transitory digital storage medium comprising a UE-signal of a wireless communication network, the UE signal comprising information for aligning a quantisation configuration between the UE and the wireless communication network.

Embodiments according to the invention comprise a device, e.g. a user equipment, e.g. a UE, e.g. a UE as shown an discussed with one of FIGS. 1 to 5, for operating in a wireless communication network (e.g. a mobile network, e.g. a WiFi network, . . . ; for example of which the UE is part of). The device is, e.g. configurable; e.g. configured, to operate a model (e.g. a model representing a quantization; e.g. a model for determining and/or predicting a measurement information (e.g. a channel state information; e.g. a precoding matrix); e.g. a model representing a combined determination and/or prediction and quantization functionality; e.g. an algorithm, e.g. comprising an algorithm to obtain measurements; e.g. a CSI prediction model) to estimate (and/or optionally to model) and/or to predict one or more parameters, e.g. a channel or a parameter relating to channel perceived by the device, and/or a characteristics, e.g. one or more channel characteristics; e.g. a beamforming characteristic, of the wireless communication network (and/or at least of a part of the wireless communication network).

A model based estimation and/or prediction of parameters and/or characteristics, e.g. parameters describing characteristics of the wireless network, allow for an efficient determination or at least approximation of said network features. In particular, the model based approach allows combining not only an estimation or respectively prediction functionality but optionally as well further functionalities such as a quantization functionality. This further allows using neural network based approaches and in particular respective training procedures.

In addition, a combination of such functionalities allows determining an information about the one or more parameters and/or characteristics of the wireless communication network, for example in one step, e.g. in a form suitable for subsequent transmission, e.g. to another network entity, for example in a quantized form.

According to embodiments of the invention, the device is, e.g. configurable; e.g. configured, to operate the model with a first configuration from a plurality of configurations, the device is, e.g. configurable; e.g. configured, to change the configuration of the model, i.e., same model, to a different second configuration; and the device is, e.g. configurable; e.g. configured, to operate the model in the second configuration, e.g. with a second configuration from the plurality of configurations.

Hence, an efficiency of the prediction and/or estimation may be increased by adapting a configuration of the model. It was recognized that network characteristics, such as channel information, may be estimated or determined more efficiently by providing a plurality of different model configurations, e.g. without having to provide structurally different models (which is however as well possible according to some embodiments). In particular, a change of the behavior or features of said characteristics may be taken into account by performing a suitable change of the configuration of the model.

According to embodiments of the invention, the device is, e.g. configurable; e.g. configured, to decide (e.g. based on one or more conditions; e.g. to decide to indicate that the device does not straight forward follow a “change signal”) to change the configuration of the model, i.e., same model, to the different second configuration and, e.g. to decide, to operate the model in the second configuration, e.g. with a second configuration from the plurality of configurations.

It was recognized that a device-sided choice of model configuration allows increasing an efficiency of the estimation and/or prediction of the parameters and/or characteristics. In particular, the device may have device-specific information available which may allow implementing a best suitable model. One or more conditions to decide may hence be reliant on device-specific information.

According to embodiments of the invention, the first configuration relates to, e.g. comprises, e.g. represents, a first set of parameters used for operating the model; and wherein the second configuration relates to a different second set of parameters used for operating the model.

Providing different sets of parameters in order to implement different configurations of the model allows providing the different configurations efficiently.

According to embodiments of the invention, the device is, e.g. configurable; e.g. configured, to operate the model with a configuration and to indicate the configuration to the wireless communication network.

It was recognized that, in particular, in a two-sided model use case, e.g. hence comprising one device-sided model and one network entity-sided model, e.g. in a base station, an indication, for example transmission, of configuration information allows adapting a corresponding model, in order to reconstruct respective parameters and/or characteristics of the network efficiently.

According to embodiments of the invention, device is, e.g. configurable; e.g. configured, to obtain, e.g. to determine; e.g. to receive, a condition of the device and/or of the wireless communication network and to change, e.g. to decide to change, the configuration based on the condition.

This may allow estimating and/or predicting the parameters and/or a characteristics of the wireless communication network efficiently.

According to embodiments of the invention, the condition relates to, e.g. is evaluated based on, at least one of:
a channel information relating to a channel of the wireless communication network
a status information relating to a state of the device
a characteristic information relating to a characteristic of the device
a capability information relating to a functionality and/or capability of the device
a model information relating to the model
a result information relating to a result obtained by the model, e.g. an additional information.

According to embodiments of the invention, the channel information comprises an information about a condition and/or about a characteristic of the channel, e.g. whether the channel comprises LOS (line of sight) and/or NLOS (no line of sight) components. Alternatively or in addition, the status information comprises an information about a state of motion of the device (e.g. a mobility aspect of the device, e.g. an information about a speed, an acceleration, and/or a doppler delay profile of the device; e.g. an information whether the device is static, e.g., not moving; e.g. (for example in case the device is static and/or not moving) an information that less quantization required; e.g. an information whether the device is moving, e.g. an information about a movement of the device; e.g. an information “low speed”, “medium speed”, and/or “high speed”, e.g., an information “high speed train”, e.g. (for example in case the device is mobile and/or moving) an information that a higher quantization required) and/or about an energy level and/or about an energy consumption of the device. Alternatively or in addition, the characteristic information comprises an information about a type of the device, e.g. such as eMBB (e.g. enhanced mobile broadband) device, V2X-UE (e.g. vehicle to X-UE), UE with NTN (Non-terrestrial Networks) support, IoT device (e.g. Internet of Things) device.

It was recognized that one or more, e.g. any combination of the above information, may allow adapting a respective configuration, in order to robustly and efficiently estimate and/or predict the parameters and/or a characteristics of the wireless communication network.

According to embodiments of the invention, the parameters and/or characteristics are and/or relate to and/or comprise an information about one or more of:
a channel state value and/or a channel state information, CSI, value
a phase
an amplitude gain and/or a channel gain
a beam forming and/or a beam forming information, BFI
a location
an angle of arrival
a distance
a time of arrival
a HARQ feedback prediction.

In particular, a model-based determination or approximation of a channel state information allows increasing an efficiency of respective transmissions in the communication channel.

According to embodiments of the invention, the model is, e.g. configurable; e.g. configured, to map a number of parameters and/or characteristics, for example of channel state information, CSI, values (e.g. in the form of a matrix; e.g. in the form of a vector; e.g. in the form of floating point numbers; e.g. in the form of integer numbers), to a, e.g. corresponding, number of quantized values.

According to embodiments of the invention, the device is, e.g. configured, e.g. configurable, to operate the model with a configuration of a plurality of configurations, wherein different configurations of the model relate to different quantisation modes (e.g. compared to the first configuration, the first configuration relating for example to another quantization mode) for quantising the parameters and/or characteristics, e.g. CSI values, e.g. compared to the first configuration.

It was recognized that selectively activating different quantization modes allows improving a precision and robustness of a determination of network information, such as a channel information and hence, as well a transmission and reconstruction of said information.

According to embodiments of the invention, a configuration relating to a quantization mode comprises an information about one or more of the following:
a number of quantization steps,
a distribution of quantization intervals,
a value range,
vector and/or scalar quantization modes.

According to embodiments of the invention, the plurality of configurations relate to a plurality of quantization modes; and wherein the plurality of quantization modes comprise at least one of
a scalar quantization mode, for example a scalar uniform quantization mode and/or a scalar non-uniform quantization mode;
a vector quantization mode.

According to embodiments of the invention, the plurality of configurations relate to different settings of respective quantization modes (e.g. for a vector quantization mode (e.g. for a vector quantization scheme) different formats and/or sizes of a vector quantization; e.g. of a vector quantization codebook; e.g. for a scalar quantization scheme whether a uniform or non-uniform quantization is performed or is to be performed, e.g. a format, e.g., a quantization granularity of the scalar quantization, e.g. a distribution of bits assigned to each float).

Hence, individual configurations may be provided not only with respect to different quantization approaches but optionally even for different variants of a respective quantization approach. This allows increasing an efficiency of the estimation and/or to prediction of the one or more parameters and/or characteristics of the wireless communication network.

According to embodiments of the invention, the model comprises a first portion, e.g. a Sensing and Compression Module; e.g. a CSI encoder, and a second portion, e.g. a Quantization Module; e.g. a quantizer, and the device is, e.g. configurable; e.g. configured, to obtain a measurement information, e.g. a Downlink CSI Matrix, indicating a condition, e.g. a condition of a channel, and/or parameter and/or characteristic of the wireless communication network, the measurement information having a first dimensionality, e.g. a measurement information in form of a matrix (e.g. having a rank, e.g. column rank, row rank of a first order). Furthermore, the device may be, e.g. configurable; e.g. configured, to provide the measurement information to the first portion of the model, e.g. approximating or relating to or performing a step similar or comparable to a Singular Value Decomposition (SVD), in order to obtain a processed version of the measurement information, e.g. a precoding matrix, with a reduced, second dimensionality, e.g. in form of a vector and the device may, for example be, e.g. configurable; e.g. configured, to provide the measurement information with the second dimensionality to the second portion of the model in order to obtain a quantized version of the second measurement information, e.g. resembling or being in the form of a precoding matrix indicator (PMI).

It was recognized that the reduction in dimension may allow compressing the information about the measurement, in order to improve the subsequent quantization.

According to embodiments of the invention, the device is, e.g. configurable; e.g. configured, to indicate, e.g., to the wireless communication network, information, such as quantisation error, associated with the operation of the model.

For example, a use of additional information, e.g. meta-information, about a functionality of the model or input of the model or constraint of the model or parameter of the model may allow increasing an efficiency of the model based estimation or prediction. As an example, based on the information, a current configuration of the model may be evaluated and hence, based on a result of the evaluation a change of configuration may be caused.

According to embodiments of the invention, the device is, e.g. configurable; e.g. configured, to determine the information associated with the operation of the model and to indicate, e.g. to trigger a signalling of, the information associated with the operation of the model if the information associated with the operation of the model fulfils a condition, e.g. so that a report (e.g. as an example of the information associated with the operation of the model) is triggered only if the information, for example, a measured quantization error, exceeds a configured threshold.

The device may, for example, be configured to determine self-diagnostic information, hence the information about the operation of its own model. Furthermore, a signaling load on a bitstream may be kept at a low level by selectively triggering the signaling of the information, e.g. by only triggering a signaling if the information is meaningful or of significance for the operation of the network.

According to embodiments of the invention, the information associated with the operation of the model comprises an information about a quantization error of the model or of a portion of the model.

It was recognized that a selective signaling of meta-data about a quantization error allows improving a reconstruction of the quantized information, as well as evaluation whether a model configuration, e.g. responsible for the respective quantization error should be changed.

According to embodiments of the invention, the information associated with the operation of the model comprises at least one of
an information about a measurement window size, e.g. a window size specified in time and/or number of measurements over which the quantization error is averaged, .e.g. uniform average, e.g. weighted average
an information about a reporting periodicity (e.g. an information whether a report is sent on a regular basis and/or an information about a number of reports, e.g., n reports with a periodicity of p, and/or an information about one or more stop criteria, e.g. of when to stop reporting other than the reporting threshold, e.g., stop reporting when the threshold does not trigger and/or after reporting n times, and/or for example if another condition is met, e.g., handover to another base station)
an information about an error metric (e.g. an information specifying the error metric that is used to determine the quantization error, e.g. an absolute error I_1, e.g. a squared error I_2, e.g. an Euclidean distance, e.g. a cosine similarity, e.g. Minkowski distance, e.g. Chebyshev distance)
a trigger information (e.g. Timetotrigger (TTT); e.g. a parameter used to avoid excessive reports when measuring the quantization error; e.g. in order to trigger or to trigger only if the quantization error exceeds a threshold for a specific number of measurements and/or a specific time and/or a specific time interval and/or a specific number of measurement windows)
an information about an average error, e.g. an average quantization error; e.g. averaged over vector and/or measurement window
an information about a quantization error, e.g. un-averaged errors; e.g. for each vector and/or for each dimension separately
an information about an error distribution (e.g. an information about a histogram, e.g. an information about fitted distribution parameters (e.g. mean and/or variance/covariance matrix for Gaussian), e.g. an information about a distribution type, e.g. about a closest distribution type (e.g. uniform, Gaussian normal, Poisson, Gamma, Chi-squared))
an information about type of configuration, for which the quantisation error is measured.

It was recognized that the above-information may provide crucial indicators for an evaluation of the operation of the model, e.g. to determine whether a change of configuration would be advantageous for the operation of the network.

According to embodiments of the invention, the device is, e.g. configurable; e.g. configured, to operate the model with the first and with the second configuration in order to obtain a comparison result, e.g. in order to decide which configuration allows a better estimation and/or prediction of the parameters and/or the characteristics of the wireless communication network.

The operation may, for example, be performed in parallel or sequentially. Hence, by comparison a configuration best suitable for the estimation and/or prediction may be chosen. As an example, the comparison may comprise an evaluation of a cost function and/or a performance of benchmark tests. The comparison may be performed according to key figures determined for both operation results, e.g. according to the first and respectively second configuration.

According to embodiments of the invention, the device is, e.g. configured, e.g. configurable, to operate a plurality of models with corresponding configurations in order to obtain a comparison result. The models may, for example, be operated in parallel or subsequently.

According to embodiments of the invention, the device is, e.g. configured, e.g. configurable, to indicate the comparison result to the wireless network, and/or the device is to switch the active configuration and/or model.

Hence, an optimization with regard to a best suited configuration may be performed and optionally communicated, in order to achieve an increase in efficiency for the estimation and/or prediction.

According to embodiments of the invention, the device is, e.g. configurable; e.g. configured, to indicate and/or to receive a configuration information of the model, e.g. as an example of an information associated with the operation of the model, and the configuration information comprises at least one of
an information about an upper bound, e.g. x_{B}, of a quantization interval
an information about a lower bound, e.g. x_{A}, of a quantization interval
an information about a granularity of the quantization, e.g. an information about a number of bits, e.g. b, assigned to a value to be quantized
an information about additional quantization bounds and corresponding quantization step values, e.g. quantization bounds (x_{A}, x_{B}_{₁}) and (x_{A}_{₂},x_{B}_{₂}) and corresponding quantization steps Δ₁ and Δ₂
an information about a quantization step vector, e.g. \vec{Δ}=(Δ₁, Δ₂, . . . , Δₙ), comprising a plurality of quantization step values.

Hence, embodiments may allow amending a respective quantization configuration in an individual manner, e.g. to optimize said quantization with regard to the specific needs for the respective application.

According to embodiments of the invention, the device is, e.g. configurable; e.g. configured, to indicate and/or to receive the configuration information or a portion thereof in the form of a look-up table and/or an information for determining the configuration information using a look-up table, e.g. so that an indication may, for example, be organized in the form of a look-up table (LUT), which comprises vectors of indices of quantization configurations (for example of uniform and/or non-uniform quantization configurations), for example, for each float number; e.g. so that, optionally only, an index of the LUT is transmitted to the wireless network.

It was recognized that the use of a LUT allows representing and/or approximating the configuration information or a portion thereof efficiently. In particular transmission of respective indices may allow reducing a use of transmission resources.

According to embodiments of the invention, the device is, e.g. configurable; e.g. configured, to indicate, e.g., to the wireless communication network, an information about a change of the model and/or of a change of a configuration of the model, such as a change of a or the configuration of the model from a or the first configuration to the a or the different second configuration, in case said change was performed and/or triggered by the device based on an evaluation of a or the condition (e.g. in case it was done autonomously at UE based on the conditions so that the quantisation configuration is aligned at UE and NW side.

For example, according to embodiments, the device may be, e.g. configurable; e.g. con-figured, to indicate, e.g., to the wireless communication network, information, such as the change of the configuration of the model from the first configuration to the different second configuration, in case it was done autonomously at UE based on the conditions so that the quantisation configuration is aligned at UE and NW side.

Hence, a corresponding entity-sided or network-sided model adaptation may be triggered. Therefore, the model configurations on device-side and on entity-side may be aligned and accordingly, parameters of the network or information about characteristics of the network may be compressed and/or quantization, transmitted and decompressed and/or dequantized efficiently.

According to embodiments of the invention, the device is, e.g. configurable; e.g. configured, to operate the model with a first configuration from a plurality of configurations; the device is, e.g. configurable; e.g. configured, to change the configuration of the model, i.e., same model, to a different second configuration and the device is, e.g. configurable; e.g. configured, to operate the model in the second configuration (e.g. with a second configuration from the plurality of configurations). Furthermore, configurations of the plurality of configurations may relate quantisation modes and the device may be, e.g. configurable; e.g. configured, to indicate, e.g., to the wireless communication network, an information about a change of the configuration of the model from the first configuration to the different second configuration, in case said change was performed and/or triggered by the device based on an evaluation of a or the condition, in order to align a quantisation configuration between the device and the wireless communication network.

According to embodiments of the invention, the device is, e.g. configurable; e.g. configured, to receive an indication indicating a command and/or a request to change a or the configuration of the model, i.e., same model, to another configuration; and/or to operate the model in the other configuration, e.g. with a second configuration from the plurality of configurations.

According to embodiments of the invention, the device is e.g. configurable; e.g. configured, to obtain an indication comprising a configuration for the operation of the model.

Hence, optionally, a change of configuration may be triggered externally, e.g. by an entity sided impulse or another device-sided but external entity.

According to embodiments of the invention, the device is, e.g. configurable; e.g. configured, to operate the model with a configuration, wherein the configuration relates to a quantization mode and the device is, e.g. configurable; e.g. configured, to indicate and/or to receive a quantization configuration information for the quantization mode, the quantization configuration information comprising a quantization configuration for a measurement value (e.g. a measurement value quantization reporting configuration (e.g. config.), e.g. a CSI_quantization_config), a list of quantization parameters (e.g. quant_parameters, e.g. a list of quant_parameters, e.g. (quant_uniform or quant_non_uniform)) and/or an error reporting information.

It was recognized that a selective adaptation of quantization model configurations for respective measurement values (e.g. different configurations for different kinds of measurements, e.g. taking into account statistical properties of said measurements), allows improving network communication significantly. This allows implementing a quantization aware model approach, e.g. device-sided as well as entity-sided.

According to embodiments of the invention, the quantization configuration for a measurement value comprises at least one of
an index information, e.g. an integer representing the index of the quantization configuration
an information about a list of quantization parameters (e.g. list quantization_params; e.g. a list of parameters describing a quantization method; e.g. a list comprising quantization_uniform and/or quantization_non_uniform configurations for example with a predefined length, e.g. n; for example referring to a quant_parameters by index)
an information about one or more conditions, e.g. conditions under which this quantization configuration should be applied
an information about an energy level and/or an energy consumption.

According to embodiments of the invention, the list of quantization parameters comprises an information about a uniform quantization, e.g. Quantization_uniform, comprising at least one of
an index information, e.g. an index; e.g. an integer representing the index of the quantization configuration
an information about a number of bits, e.g. N_bits; e.g. a number of bits used for representation
an information about a lower bound of the quantization, e.g. X_start; e.g. a starting value of the range, e.g. quantization range
an information about a size of a quantization range, e.g. X_length; e.g. a length of the range, e.g. quantization range; and/or
wherein the list of quantization parameters comprises an information about a non-uniform quantization, e.g. Quantization_non_uniform, comprising at least one of
an index information, e.g. an index; e.g. an integer representing the index of the quantization configuration
an information about quantization values (e.g. X_value; e.g. a list of values used for non-uniform quantization; e.g. a list comprising values of type int, float and/or enum, and/or wherein optionally the length of the list may give or represent a number of bits used for representation)
an information about a lower bound of the quantization (e.g. X_start; e.g. a starting value of the range, e.g. quantization range), an information about a upper bound of the quantization (e.g. X_end; e.g. a starting value of the range, e.g. quantization range) and an information about a quantization steps (e.g. as an alternative to the information about quantization values).

Hence, optimization of a plurality of setting parameters may be performed for obtaining an efficient configuration of the model.

According to embodiments of the invention, the device is, e.g. configurable; e.g. configured, to operate at least a portion of the model with a fixed configuration; and/or the device is, e.g. configurable; e.g. configured, to exchange at least a portion of the model.

It was recognized that performing a structural adaptation of a respective model allows introducing another degree of freedom for optimization.

According to embodiments of the invention, the device is, e.g. configurable; e.g. configured, to change the configuration of the model in a training phase of the model or in a training phase of a portion of the model; and/or the device is, e.g. configurable; e.g. configured, to change the configuration of the model in an inference phase of the model during operation of the wireless communication network.

According to embodiments of the invention, the parameters and/or a characteristics of the wireless communication network relate to at least one of
channel state information
beamforming,
positioning, and/or localization,
network traffic forecasting,
modulation and coding scheme (MCS) selection,
interference management,
handover prediction,
quality of experience (QoE) and/or quality of service (QoS) predictions and/or
device-to-device (D2D) communication.

According to embodiments of the invention, the device is, e.g. configured, e.g. configurable, to operate the model with a first configuration from a plurality of configurations, the device is, e.g. configured, e.g. configurable, to change the configuration of the model to a different second configuration and the device is, e.g. configured, e.g. configurable, to operate the model in the second configuration. Alternatively or in addition, the device is, e.g. configured, e.g. configurable, to operate the model with a configuration and the device is, e.g. configured, e.g. configurable, to indicate the configuration to the wireless communication network. Furthermore, the device may be, e.g. configured, e.g. configurable, to obtain a condition of the device and/or of the wireless communication network and to change the configuration based on the condition and the condition may relate to at least one of
a beamforming characteristic
a positioning, and/or localization information
a network traffic forecast information
a modulation and coding scheme selection
an interference management information
a handover prediction
a quality of experience and/or quality of service predictions and/or device-to-device communication
mobility and/or environmental changes
measurements, such as Received Signal Strength Indicator, Time of Arrival and/or Angle of Arrival
local signals, such as WiFi
predicted channel quality
network parameters.

Further embodiments according to the invention comprise an entity, e.g. a base station, e.g. BS, for operating in a wireless communication network (e.g. a mobile network, e.g. a WiFi network, . . . ; for example of which the BS is part of), wherein the entity is, e.g. configurable; e.g. configured, to control, e.g. to adapt, e.g. to influence, operation of a model at a device, e.g. a user equipment, e.g. a UE, in the wireless communication network, the model adapted to estimate (and/or to model) and/or to predict one or more parameters, e.g. a channel perceived by the device, and/or a characteristics, e.g. one or more channel characteristics; e.g. a beamforming characteristic, of the wireless communication network.

According to embodiments of the invention, the entity is, e.g. configurable; e.g. configured, to control (e.g. in the form of influencing, e.g. to conditionally induce) a change of a configuration of the model from a first configuration of a plurality of configurations to a different second configuration.

According to embodiments of the invention, the entity is, e.g. configurable; e.g. configured, to cause the wireless communication network to signal, e.g. via itself, to the device, condition information related to a condition in which (e.g. based on a decision of the device based on an evaluation of the condition) the configuration of the model of the device is to be changed from the first configuration to the different second configuration, e.g. so that a change of configuration is caused.

According to embodiments of the invention, the entity is, e.g. configured, e.g. configurable, to receive an information about the configuration of the model.

The entity as described above may be based on the same considerations as the above-described device. The entity can, by the way, be completed with all features and functionalities, which are also described with regard to the device, both individually and taken in combination, e.g. in a corresponding or similar manner.

Further embodiments according to the invention comprise a signal of a wireless communication network (e.g. a mobile network, e.g. a WiFi network, . . . ) the signal comprising information, such as quantisation error, associated with an operation of a model at a device in the wireless communication network.

Further embodiments relate to an UE-signal of a wireless communication network, the UE signal comprising information for aligning a quantisation configuration between the UE and the wireless communication network.

For example, embodiments may further comprise a UE-signal comprising information, such as the change of the configuration of the model from the first configuration to the different second configuration, so that the quantisation configuration is aligned at UE and NW side.

According to embodiments of the invention, the information comprises an information about a change of a configuration of a model, an operation of which is performed in the UE, from a first configuration to a different second configuration, so that the a quantisation configuration is aligned at UE and NW network side

Further embodiments according to the invention comprise a signal of a wireless communication network (e.g. a mobile network, e.g. a WiFi network, . . . ) and comprising instructions, for a device operating in the wireless communication network to control operation of a model at the device, the model adapted to estimate (and/or to model) and/or to predict one or more parameters, e.g. a channel perceived by the device, and/or a characteristic (e.g. one or more channel characteristics; e.g. a beamforming characteristic) of the wireless communication network.

According to embodiments of the invention, the instructions comprise an information for controlling, e.g. in the form of influencing, e.g. to conditionally induce, a change of a configuration of the model from a first configuration of a plurality of configurations to a different second configuration.

According to embodiments of the invention, the instructions comprise condition information related to a condition that causes the device to change a configuration of the model from a first configuration to a different second configuration.

The signals as described above may be based on the same considerations as the above-described device and/or entity. The signals can, by the way, be completed with all features and functionalities, which are also described with regard to the device and/or entity, both individually and taken in combination, e.g. in a corresponding or similar manner.

Further embodiments according to the invention comprise a method for operating a device, e.g. a user equipment, e.g. a UE, in a wireless communication network (e.g. a mobile network, e.g. a WiFi network, . . . ; for example of which the UE is part of), wherein the method comprises operating a model (e.g. a model representing a quantization; e.g. a model for determining and/or predicting a measurement information (e.g. a channel state information; e.g. a precoding matrix); e.g. a model representing a combined determination and/or prediction and quantization functionality; e.g. an algorithm, e.g. comprising an algorithm to obtain measurements; e.g. a CSI prediction model) to estimate (and/or to model) and/or to predict one or more parameters, e.g. a channel perceived by the device, and/or a characteristic, e.g. one or more channel characteristics; e.g. a beamforming characteristic, of the wireless communication network.

According to embodiments of the invention, the model comprises operating the model with a first configuration from a plurality of configurations, changing the configuration of the model, i.e., same model, to a different second configuration and operating the model in the second configuration, e.g. with a second configuration from the plurality of configurations.

Further embodiments according to the invention comprise a method for operating an entity, e.g. a base station, e.g. BS, in a wireless communication network (e.g. a mobile network, e.g. a WiFi network, . . . ; for example of which the BS is part of), wherein the method comprises controlling, e.g. to adapting, e.g. to influencing, operation of a model at a device, e.g. a user equipment, e.g. a UE, in the wireless communication network, the model adapted to estimate (and/or to model) and/or to predict one or more parameters, e.g. a channel perceived by the device, and/or a characteristic, e.g. one or more channel characteristics; e.g. a beamforming characteristic, of the wireless communication network . . .

According to embodiments, the controlling of the operation of the model comprises controlling a change of a configuration of the model from a first configuration of a plurality of configurations to a different second configuration.

Further embodiments according to the invention comprise a computer program for performing any of the methods as disclosed herein, when the computer program runs on a computer.

The methods as described above may be based on the same considerations as the above-described device and/or entity. The methods can, by the way, be completed with all features and functionalities, which are also described with regard to the device and/or entity, both individually and taken in combination, e.g. in a corresponding or similar manner.

### BRIEF DESCRIPTION OF THE DRAWINGS

Embodiments of the present invention will be detailed subsequently referring to the appended drawings, in which:

FIG. 1a shows a schematic representation of an example of a wireless communication system according to embodiments of the invention;

FIG. 1b is a schematic representation of an example of a radio access network;

FIG. 2 shows a schematic representation of an in-coverage scenario in which UEs directly communicating with each other are connected to a base station according to embodiments of the invention;

FIG. 3 shows a schematic representation of an out-of-coverage scenario in which UEs directly communicating with each other receive no SL resource allocation configuration or assistance from a base station according to embodiments of the invention;

FIG. 4 shows a schematic representation of a partial out-of-coverage scenario in which some of the UEs directly communicating with each other receive no SL resource allocation configuration or assistance from a base station according to embodiments of the invention;

FIG. 5 shows a schematic representation of an in-coverage scenario in which UEs directly communicating with each other are connected to different base stations according to embodiments of the invention;

FIG. 6 shows a schematic representation of a wireless communication system comprising a transceiver, like a base station or a relay, and a plurality of communication devices, like UEs, according to an embodiment;

FIG. 7 shows a schematic representation of a CSI Compression and Quantization Pipeline according to embodiments of the invention;

FIG. 8 shows a schematic representation of a uniform quantization according to embodiments of the invention;

FIG. 9 is a schematic representation of a uniform quantization with two different quantization bounds and corresponding quantization steps according to embodiments of the invention;

FIG. 10 shows a schematic representation of a non-uniform quantization according to embodiments of the invention; and

FIG. 11 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

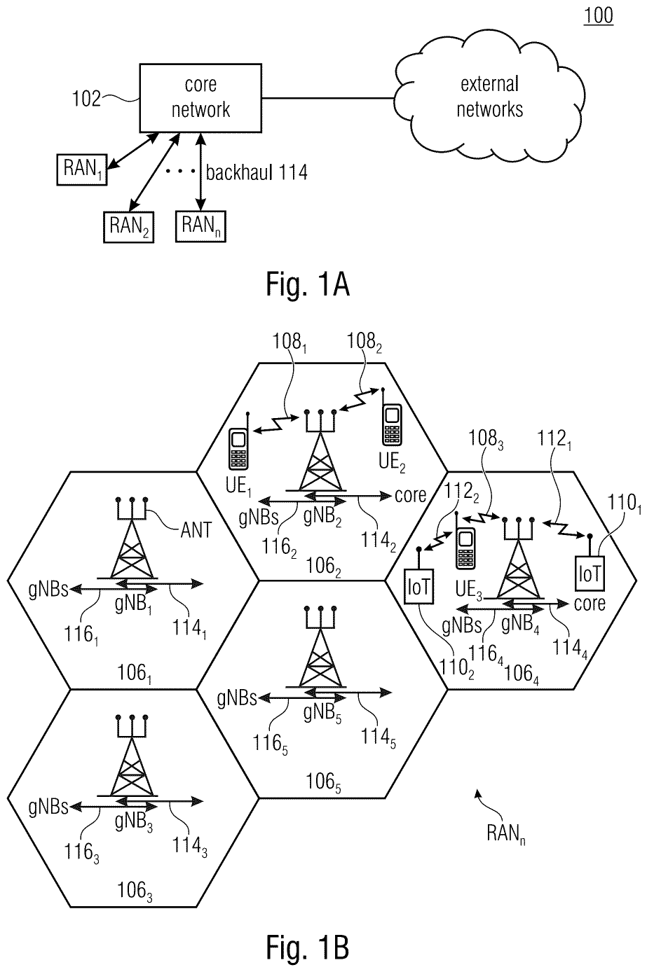

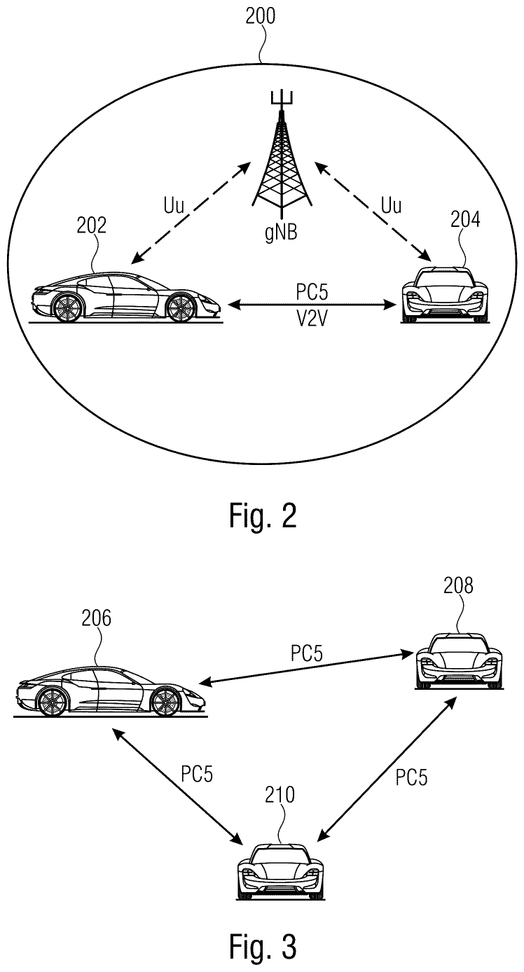

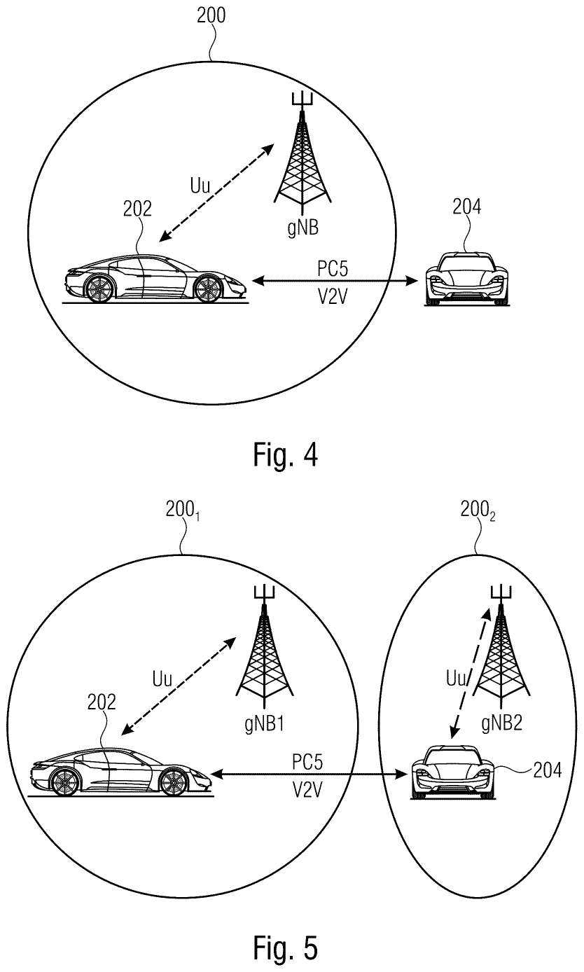

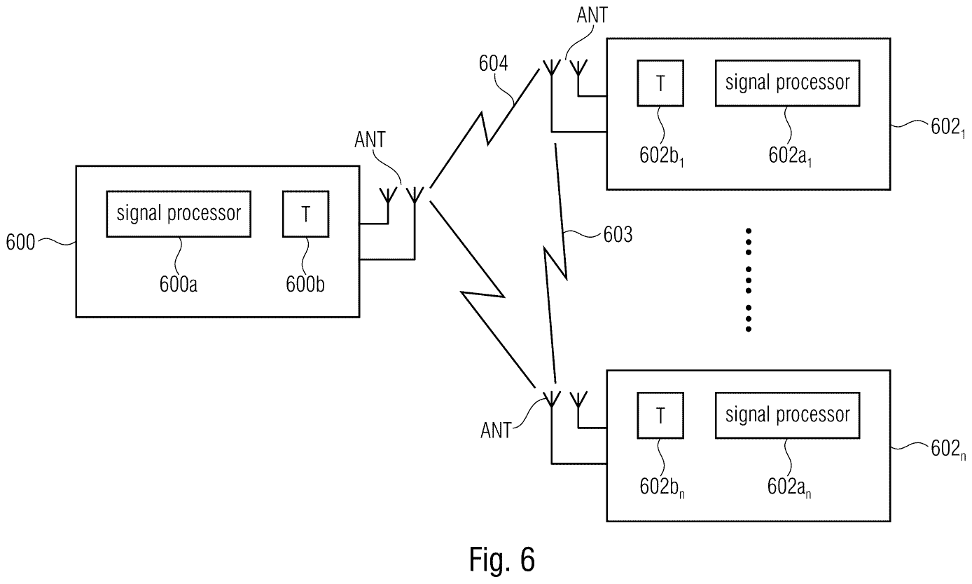

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 600, like a base station or a relay, e.g. an entity for operating in a wireless communication network according to embodiments, and a plurality of communication devices 602₁ to 602ₙ, like UEs, e.g. devices for operating in the wireless communication network according to embodiments. The UEs might communicated directly with each other via a wireless communication link or channel 603, like a radio link (e.g., using the PC5 interface (sidelink)). Further, the transceiver and the UEs 602 might communicate via a wireless communication link or channel 604, like a radio link (e.g., using the uU interface). The transceiver 600 might include one or more antennas ANT or an antenna array having a plurality of antenna elements, a signal processor 600a and a transceiver unit 600b. The UEs 602 might include one or more antennas ANT or an antenna array having a plurality of antennas, a processor 602a₁ to 602aₙ, and a transceiver (e.g., receiver and/or transmitter) unit 602b₁ to 602bₙ. The base station 600 and/or the one or more UEs 602 may operate in accordance with the inventive teachings described herein.

Hence, a communication device 602_{1, . . . , n}, e.g. a UE, as shown in FIG. 6 may be configured to operate a model to estimate and/or to predict one or more parameters and/or a characteristics of the wireless communication network, e.g. a characteristic of the channel 604 (e.g. a quantized version thereof).

Accordingly, an entity of the wireless network, e.g. represented by transceiver 600, e.g. a base station as an example of an entity according to embodiments, may be configured to control operation of a model at a device, e.g. 602_{(1, . . . , n)}, hence, e.g. one of the UEs, in the wireless communication network, wherein the model is adapted to estimate and/or to predict one or more parameters and/or a characteristics of the wireless communication network, e.g. a characteristic of the channel 604 (e.g. a quantized version thereof).

Accordingly, via communication link 604 (e.g. representing a signal provided via said communication link), a signal according to embodiments may be provided.

As an example, the signal may comprise an information, such as quantization error, associated with an operation of a model at a device 602₁₋ₙ in the wireless communication network.

As another example, said signal may be an UE-signal of a wireless communication network, the UE signal comprising information for aligning a quantization configuration between the UE 602_{1, . . . , n} and the wireless communication network.

As another example, the signal may comprise instructions, for a device 602_{1, . . . , n} operating in the wireless communication network to control operation of a model at the device, the model adapted to estimate and/or to predict one or more parameters and/or a characteristics of the wireless communication network.

As indicated by 603, embodiments may further comprise a respective sidelink communication, wherein device 602₁ may perform the above-discussed functionality of the entity 600 for device 602ₙ and optionally vice-versa.

In the following section that may be titled “Channel State Information (CSI) feedback quantization according to embodiments of the invention” further embodiments of the invention will be discussed and other embodiments will be explained in other words or with additional optional features.

Also, further embodiments will be defined by the enclosed claims.

It should be noted that any embodiments as defined by the claims can be supplemented by any of the details (features and functionalities) described herein and in particular in the following section.

Also, the embodiments described herein can be used individually, and can also be supplemented by any of the features in another section of the present disclosure, or by any feature included in the claims.

Also, it should be noted that individual aspects described herein can be used individually or in combination. Thus, details can be added to each of said individual aspects without adding details to another one of said aspects.

Moreover, features and functionalities disclosed herein relating to a method can also be used in an apparatus (configured to perform such functionality). Furthermore, any features and functionalities disclosed herein with respect to an apparatus can also be used in a corresponding method. In other words, the methods disclosed herein can be supplemented by any of the features and functionalities described with respect to the apparatuses.

Also, any of the features and functionalities described herein can be implemented in hardware or in software, or using a combination of hardware and software, as will be described in the section “implementation alternatives”

The following section may be titled “Channel State Information (CSI) feedback quantization according to embodiments of the invention”.

### Introduction to Embodiments

According to the latest 3gpp agreements there exist two types of AI/ML training (e.g. Artificial Intelligence and/or Machine Learning Training) with or without quantization awareness. In non-aware training, variables of the CSI encoded data, for example the float-format variables of the CSI encoded data, may, for example, be passed, optionally directly passed, from CSI generation part to CSI reconstruction part. Therefore, fixed/pre-configured quantization method/parameters (e.g. fixed and/or pre-configured quantization method and/or fixed and/or pre-configured quantization parameters) can be applied for the inference phase. In quantization-aware training, there exist, for example, at least two cases:
1) fixed/pre-configured quantization method/parameters may, for example, be applied during the training phase and the same quantization codebook may, for example, be applied for the inference phase
2) quantization method/parameters may, for example, be updated in together with the AI/ML models during the training; when training is finished, the final quantization codebook may, for example, be applied for the inference phase

Moreover, the ground truth data in CSI compression use case can, for example, be quantized by high resolution quantization methods and optionally transmitted to the NW for monitoring purposes. The following agreement has, as an example, been achieved in RAN1-113 meeting:

In CSI compression using two-sided model use case, further study the necessity and potential specification impact on quantization alignment, including at least:
For vector quantization scheme,
   The format and size of the VQ codebook
   Size and segmentation method of the CSI generation model output
For scalar quantization scheme,
   Uniform and non-uniform quantization
   The format, e.g., quantization granularity, the distribution of bits assigned to each float.
Quantization alignment using 3 GPP aware mechanism.

The following proposal studies the quantization alignment using 3gpp aware mechanism.

However, it is to be noted that embodiments are not limited to an alignment of quantization approaches. Quantization may be part of the operation of the model but any other model-related functionality having a counterpart in a respective entity such as a base station may be aligned. As an example, apart from an alignment of a quantization and de-quantization, a compression and decompression functionality may be aligned and/or a combination of compression and quantization with a combination of de-quantization and decompression.

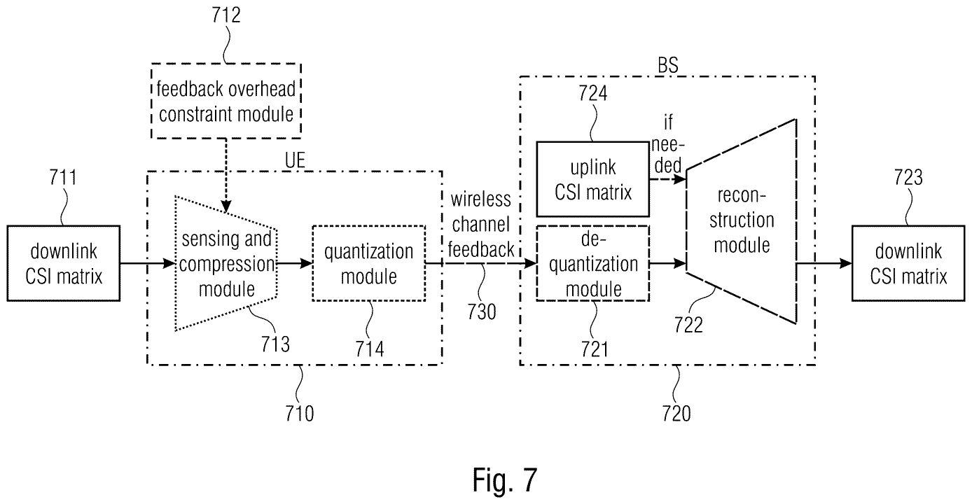

Reference is made to FIG. 7. FIG. 7 shows schematic representation of a CSI Compression and Quantization Pipeline according to embodiments of the invention. In other words, FIG. 7 shows an example of a possible CSI Compression and Quantization Pipeline. FIG. 7 shows a device 710, as an example in the form of a user equipment, UE (e.g. being an example of a UE shown in FIGS. 1 to 6), and an entity 720, as an example in the form of a base station, BS (e.g. being an example of a base station shown in FIGS. 1, 2, 4, 5 and 6). The device is provided with a downlink CSI matrix 711 and is optionally as well provided with additional information by an optional feedback overhead constraint module 712. The device 710 comprises a Sensing and Compression Module 713 and a Quantization Module 714. The device 710 is configured to provide a wireless channel feedback information 730 to the entity 720.

Entity 720 comprises a De-quantization Module 721 and a Reconstruction Module 722. The De-quantization Module 721 may be configured to de-quantize the wireless channel feedback information 730 and to provide the same to the Reconstruction Module 722 in order to obtain an information 723 about the Downlink CSI Matrix 711 or even the Matrix 711 itself. Optionally, the Reconstruction Module 722 may be provided with an Uplink CSI Matrix 724

The sensing and compression module 713 as well as the reconstruction module 722 can, for example, comprise or even be AI/ML models.

Part of the Base station functions may, for example, be computed in the core network or cloud.

As an example, in FIG. 7, the UE may be an example for a device according to embodiments and the BS may be an example for an entity according to embodiments. UE and BS may be part of a same wireless communication network, e.g. a RAN as previously discussed. As an example, the UE may comprise a model, for example a model trained using AI/ML. As an example, the sensing and compression module 713 may be implemented or represented by such a model, for example, for processing the downlink CSI matrix 711. Optionally, the model may as well represent (e.g. as an implementation thereof) the Quantization module 714, for example as a second portion of the model. However, it is to be noted that the model of the device 710 may as well only represent such a Quantization module 714. The device 710 may be configured to provide an information about the channel to the base station 720, as a channel state information, e.g. as an example of the wireless channel feedback 730.

The device 710 may be configured to change a configuration of its model, for example in particular its configuration with regard to a quantization method implemented. Such an adaptation may be performed in a training phase of a respective model as well as in an inference phase. In particular, the device may optionally be configured to decide which configuration of a plurality of configurations to use, for example based on an evaluation of a condition. Optionally, the device 710 may be configured to indicate such a configuration or choice of configuration to a respective basestation or more generally the network. The condition may in particular be related to a channel characteristic.

The device 710 may as well be configured to receive such a condition information from the basestation, in order to control a changing of a configuration of the model. Although depicted for the case of a channel state information, a configuration adaptation according to embodiments may as well be directed to other entities such as beamforming characteristics, e.g. for a quantization and indication thereof.

Hence, a model according to embodiments may in general allow to model and/or to predict and/or to extract an information which is to be quantized and transmitted. However, as discussed above, the model may as well represent the quantization, so that an operation of the model with an input information may allow providing an extracted and as well quantized information for transmission.

In general, the model may as well implement an encoding functionality (and accordingly a model on a BS or network side a respective decoding functionality).

The above explained features may be implemented accordingly on the BS or NW side with corresponding functionality, in particular with regard to decoding and dequantization, as well as reconstruction. Any of such functionality may be modeled using a model.

### General Description of Aspects of Embodiments

In general, quantization methods may, for example, include uniform vs non-uniform quantization, scalar versus vector quantization. In scalar quantization, a or for example even each number, optionally in the float-format sequence, may, for example, be or will be mapped to several bits, whereas in vector quantization, a or even each sub-sequence of (optionally) float-format sequence may, for example, be or will be mapped to several bits.

### A. Uniform Quantization

In scalar quantization the number of bits b can, for example, be directly assigned to each float number. A simple or even the simplest case of the scalar quantization is, for example, a uniform one, which may, for example, be characterized by the constant quantization step:

$$△ = \frac{{x}_{B} - {x}_{A}}{N} ,$$

where x_{A},x_{B}—are the lower and higher bounds of the vector of CSI floats, \vec{x}, respectively; and N=2^{b}—is a number of quantization levels. The compressed CSI values may have or may generally have different patterns, varying from dense to more scattered scenarios.

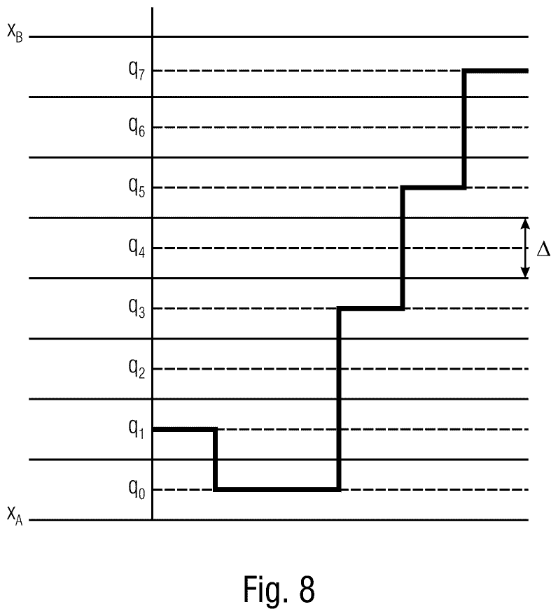

Reference is made to FIG. 8. FIG. 8 is a schematic representation of a uniform quantization according to embodiments of the invention. FIG. 8 presents an example of uniform quantization for N=8. Here, the quantization levels (e.g. q₀ to q₇) are optionally specified at the center of each quantization step (e.g. having a step size of Δ).

By signaling the x_{A},x_{B} lower and higher bounds to the NW and the number of bits b assigned to each float, different quantization step functions may, for example, be configured, which may reduce the quantization error and may better align with various quantization patterns of CSI encoded values.

Note that the given values for uniform quantization might be signaled per every CSI report and/or configured for specific scenario/model (e.g. for specific scenarios and/or models). For example, the number of bits b assigned to each float may, for example, be fixed for the given scenario/model and (optionally only) x_{A}, x_{B} may, for example, be reported to the NW (e.g. network), which may control the quantization granularity. Moreover, x_{A}, x_{B} may take other than minimum and maximum values of the vector, for example, to better adapt to the scattering pattern of the CSI values, e.g. after removing the outliers. The given pre-processing might optionally be performed as a prior to quantization procedure.

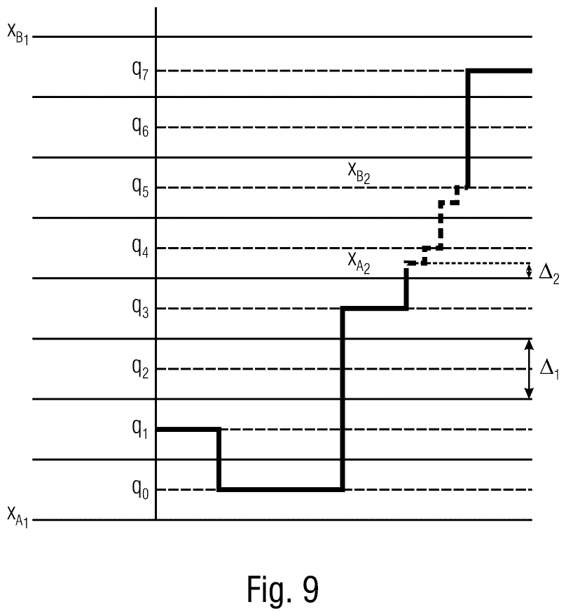

B. Uniform Quantization with Multiple Quantization Granularity Distribution of the compressed CSI values may, for example, be or may be generally non-uniform, e.g. distributing densely around 0 but sparsely elsewhere. In that sense uniform quantization with multiple quantization bounds and corresponding quantization steps might optionally be applied to the floating points. A high-level example of the given scenario is presented in FIG. 9, where uniform quantization is used with two different quantization bounds (x_{A}, x_{B}_{₁}) and (x_{A}_{₂}, x_{B}_{₂}) and corresponding quantization steps Δ₁ and Δ₂.

Here x_{A}_{ᵢ}, x_{B}_{ᵢ} values might optionally be configured in a common way or separately for each of the N number of quantization levels and signaled to the NW. In that way, different bit levels may, for example, have their own quantization step with a uniform allocation within the given bit level. Alternatively, bit levels might have multiple x_{A}_{ᵢ}, x_{B}_{ᵢ} intervals to better adapt to the scattering pattern of the CSI distribution.

Note that the bit-specific x_{A}_{ᵢ}, x_{B}_{ᵢ} values for uniform quantization might optionally be signaled per every CSI report and/or configured for specific scenario/model.

The signaling might optionally be also organized in the form of a look-up table (LUT), which comprises the vector of indeces (e.g. indices) of uniform quantization configurations, for example, for each float number. Then, optionally only, the index of the LUT may to be or is to be transmitted to the NW.

### C. Non-Uniform Quantization

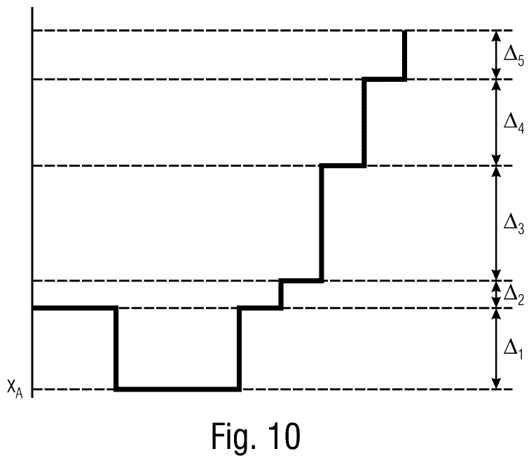

As was already mentioned above, distribution of the compressed CSI values may, for example, be or may be generally non-uniform, e.g. distributing densely around 0 but sparsely elsewhere. Non-uniform quantization with selected levels that are characterized by a varying quantization step might optionally better adapt to the scattering pattern of the CSI distribution. The high level overview of the non-uniform quantization is demonstrated in FIG. 10, as an example.

The signaling of the non-uniform quantization optionally includes transmission of one or more of the following parameters:
Low bound x_{A} (and/or upper bound x_{B})
Quantization step vector \vec{Δ}=(Δ₁, Δ₂, . . . , Δₙ)

Note that the parameters for non-uniform quantization might optionally be signaled per every CSI report and/or configured for specific scenario/model.

The signaling might optionally be also organized in the form of a look-up table (LUT), which comprises the vector of indeces (e.g., indices) of uniform and/or non-uniform quantization configurations, for example for each float number. Then, optionally only, the index of the LUT may to be or is to be transmitted to the NW.

### D. Quantization Error

The typical autoencoder-based approach optionally includes two steps procedure: a CSI encoder and a quantizer at the UE (e.g. user equipment) side, and the corresponding two steps procedure: de-quantizer and CSI decoder at the NW side. By having the information of the quantization error available at the NW side, the more accurate reconstruction of the CSI feedback can, for example, be achieved. Therefore, quantization error may, for example, be or should be signaled from the UE to the NW in a CSI report to reduce the quantization loss.

In a quantization aware AI/ML case with both fixed/pre-configured quantization method/parameters and learned quantization method, the quantization error might optionally be signaled during the training and/or inference stage and/or monitoring phase to the NW, for example, to enhance the reconstruction procedure and/or to evaluate the performance. In that way, the signaled quantization error may, for example, be used as input by the reconstruction model at the NW and/or as a post-processing operation, for example during the de-quantization. Furthermore, the quantization error may optionally be used to decide whether the model fits the current situation. Otherwise, a model switch may optionally be initiated. In another embodiment, the quantization error may, for example, be reported, e.g. when a trigger is activated. The trigger may, for example, be a certain threshold of the average quantization error over a certain time window and/or a number of measurements.

In a quantization non-aware AI/ML case, the quantization error might optionally be signaled during the inference stage to the NW, for example to be used as a post-processing operation, for example during the de-quantization.

The quantization error might optionally comprise the quantization loss values computed as a mean squared values per bit level in a uniform quantization case and/or per selected quantization code word in a LUT.

The following delineates multiple illustrative use cases that demonstrate the applicability and versatility of embodiments of the present invention where optionally AI/ML models are used to predict and/or estimate certain parameters or characteristics in a wireless communication system. Hence, embodiments may comprise one or more of the following functionalities, and/or may be used for one or more of the following applications:
1. Beamforming:
   Predicting the optimal beamforming vectors for massive MIMO (Multiple-Input,
   Multiple-Output) systems; and/or.
   Dynamic adaptation of beam patterns based on user mobility and/or environmental
   changes; and/or
   Interference management, for example, in multi-user scenarios.
2. Positioning and Localization:
   Predicting the (e.g. precise) location of devices, for example, based on measurements like RSI (Received Signal Strength Indicator), Time of Arrival (ToA), and/or Angle of Arrival (AoA); and/or
   Indoor positioning systems, for example, using WiFi or other local signals.
3. Network Traffic Forecasting:
   Predicting network congestion and/or traffic patterns.
4. Modulation and Coding Scheme (MCS) Selection:
   Adaptive modulation and/or coding, for example based on predicted channel quality
6. Interference Management:
   Predicting interference, for example, in dense deployment scenarios.
8. Handover Prediction:
   Optimizing handover parameters, for example, to reduce call drops and/or to ensure QoS (Quality of Service)
9. Quality of Experience (QoE) and/or Quality of Service (QoS) Predictions:
   Predicting user satisfaction, for example, based on various network parameters; and/or
   Adaptive video streaming strategies, for example, based on predicted QoE.
10. Device-to-Device (D2D) Communication:
   Peer selection, for example optimal peer selection, optionally for D2D communications; and/or
   Resource sharing strategies among D2D users.

Accordingly, it is to be noted that the parameters and/or a characteristics of the wireless communication network (that may be modelled, predicted and/or estimated) optionally relate to at least one of a channel state information, beamforming, positioning, and/or localization, network traffic forecasting, modulation and coding scheme (MCS) selection, interference management, handover prediction, quality of experience (QoE) and/or quality of service (QOS) predictions and/or device-to-device (D2D) communication.

### Proposal

We propose the following signaling via RRC (e.g. Radio Resource Control) using the defined above parameters. In other words, embodiments may comprise or be based on the following signaling via RRC (e.g. Radio Resource Control) using the defined above parameters.
0. Quantization Config
   List of quant_parameters (quant_uniform (or Quantization_uniform) or quant_non_uniform (or Quantization_non_uniform)) can, for example, be referred by index by the configs below. Some parameters might optionally be pre-configured (For example: value 0-31 fixed and only 32-63 are changable.)
   CSI quant_config (or CSI_quantization_config)
   Error Reporting_quant config (or Error_report_config)

In a further embodiment the configuration can comprise, or for example contain, different quantization configuration. E.g for one or more of: beamforming, positioning and/or localization, network traffic forecasting, modulation and coding scheme (MCS) selection, interference management, handover prediction, quality of experience (QoE) and/or quality of service (QoS) predictions and/or device-to-device (D2D) communication.

### 1. CSI_Quantization_Config: (More General Measurement Value Quantization Reporting Config)

Index: integer representing the index of the quantization configuration
List quantization_params: list of parameters describing the quantization method. The list can, for example comprise or contain either quantization_uniform or quantization_non_uniform configurations with length n. Alternatively it can, for example, refer to the quant_parameters by index.
Conditions: conditions under which this quantization configuration should be applied. The conditions can include (e.g. at least one of the following)
   channel condition
      LOS/NLOS-components (e.g. line-of-sight and/or no line-of-sight components),
   mobility aspects
      dependent on speed, acceleration, doppler delay profile,
      UE is static, e.g., not moving, for example less quantization required,
      UE is moving, e.g., low speed, medium speed, high speed, e.g., high speed train, for example higher quantization required.
   Type of device/UE
      eMBB device (e.g. enhanced mobile broadband device), V2X-UE (e.g. vehicle to X UE), UE with NTN support (e.g. non-terrestrial network support), IoT device (e.g. Internet of Things device), etc.
   Device capabilities
   Depending on model/algorithm used to obtain measurements (e.g. CSI prediction model)
   Depending on additional information (e.g. output parameter) provided by the model or algorithm (e.g. CSI prediction model has a further output to support the choice of the right quantization to use)
Processing power, batter level, etc. In another embodiment, the device may, for example, use, or would use more than one quantization config, e.g., 2 different quantization configurations for example for the same radio channel, and optionally signal to the NW which quantization technique it used, directly or indirectly. In this way, the NW could, for example, evaluate which quantization technique provides the better feedback, e.g., based on an error measure.

### 2. Quantization_Uniform:

Index: integer representing the index of the quantization configuration
N_bits: number of bits used for representation
X_start: starting value of the range
X_length: length of the range

### 3. Quantization_Non_Uniform:

Index: integer representing the index of the quantization configuration
X_value: list of values used for non-uniform quantization. The list can, for example comprise or contain values of type int, float and/or enum, and the length of the list may, for example, give the number of bits used for representation.
   Or as an alternative (X_start and/or X_end and a vector of quantization steps might optionally be signaled)

### 4. Error_Report_Config:

Reporting threshold: Report may, for example, be triggered optionally only if measured quantization error exceeds the configured threshold:
Measurement window size: window size specified in time and/or number of measurements over which the error is averaged, .e.g. uniform average, weighted average.
Reporting periodicity: If report is sent on a regular basis and the number of reports, e.g., n reports with a periodicity of p, or a stop criteria, of when to stop reporting other than the reporting threshold, e.g., stop reporting when the threshold does not trigger and/or after reporting n times, or if another condition is met, e.g., handover to another base station.
Error metric: may specify the error metric that is used to determine the error, e.g. absolute error I_1, squared error I_2, Euclidean distance, cosine similarity, Minkowski distance, Chebyshev distance
Timetotrigger (TTT): this parameter may, for example, be used for to avoid excessive reports when measuring the quantization error. For example only trigger if error exceeds threshold for n measurements or t_n time or k measurement windows.
Change to last report

### 5. Error_Report:

Average error (e.g. averaged over vector and/or measurement window)
Raw error data (e.g. unaveraged errors for example for each vector or for each dimension separately)
Distribution of errors for example at least one of: histogram, fitted distribution parameters (e.g. mean and variance/covariance matrix for Gaussian), closest distribution type (e.g. uniform, Gaussian normal, Poisson, Gamma, Chi-squared)

In a further embodiment the BS may be another UE (e.g. in case of PC5 sidelink communication).

In a further embodiment the UE may be a Wifi STA (e.g. non-AP station) and/or the BS may be another Wifi STA (e.g. AP-STA). Further both the UE and BS may be of type non-AP-STA or AP-STA. (e.g. in the case of mesh networking or direct communication) (wherein, for example, AP: Access Point and STA: station).

Hence, as an example, with regard to the above signaling, embodiments may comprise a communication, e.g. from UE to NW indicating a configuration of the model of the UE, for example regarding a quantization configuration.

Furthermore, the communication may comprise model meta information, for example in the form of a quantization error, which may allow improving a reconstruction of the transmitted information on the NW side.

Referring to FIG. 7 again, in view of the above disclosure, FIG. 7 is to be discussed again, as an additional example in other words. In general terms, FIG. 7 may show a device 710 for operating in a wireless communication network, wherein the device is to operate a model to estimate and/or to predict one or more parameters and/or a characteristics of the wireless communication network. The model may hence comprise the Sensing and Compression Module 713, e.g. as a first portion of the model and/or the Quantization module 714, e.g. a second portion of the model. However, the model may as well only comprise the Quantization module 714, e.g. without Module 713, which may optionally not be present or which may, for example, be implemented in a different manner. Hence, the model may in particular be associated with a quantization functionality.

The device 710 may predict and/or estimate an information, e.g. a quantized information, about a feature of the network. Therefore, the device may be configured to operate said model in different configurations, e.g. characterized by different sets of parameters. In particular, the different configuration may relate to different quantization modes or quantization approaches, such as the above-discussed, e.g. uniform quantization, uniform quantization with multiple quantization granularity and/or non-uniform quantization with their respective different parameters, for configuring the model. Yet, different configurations may as well correspond to different settings of a respective quantization mode, hence for example different variants of non-uniform quantization.

An adaptation of the configuration of the model may be performed with respect to a condition of the device and/or of the wireless communication network. In the example of FIG. 7 the condition may be a condition of a channel of the network. A respective condition information may be provided to the UE 710, or optionally, the UE may receive a measurement information, such as the Downlink CSI Matrix 711 in order to determine the condition.

Therefore, the Sensing and Compression Module 713, e.g. as first portion of the model may, for example, be configured to provide a processed version of the measurement information, e.g. in the form of a precoding matrix, whilst optionally reducing a dimensionality of the processed version of the information in comparison to the input. Hence, the processed version may then be provided to the quantization module 710 as input. In other words, the model may be configured to extract an information, e.g. a preprocessed version thereof, of a feature of the network.

Anyways, in general, based on a processed or unprocessed condition information the device may adapt its model by changing a configuration of the model to adapt estimation and/or prediction, e.g. quantization of a characteristic. Optionally, the condition information may, for example, at the same time, form an input for the estimation or prediction itself.

Hence, embodiments may provide an adaptive model, wherein an input of the model may not only be processed but may at the same time determine a configuration of the model. Hence, the model may adapt “itself” to the input, in order to optimize estimation and/or prediction.

Here, it is to be noted that according to some embodiments, an input based on which the configuration of the model is adapted may be different from an input based on which the estimation and/or prediction is performed.

In addition or as an alternative to a configuration change based on an external or internal information, the UE 710 may be configure to run one or more model configurations in sequence or even in parallel, in order to compare respective outputs and to choose, e.g. based on one or more criteria, such as quality criteria, e.g. based on an evaluation of a cost function, which configuration to use. Hence, a UE may comprise active and inactive configurations.

Apart from receiving new configurations themselves, an external entity, e.g. within the network, e.g. a base station 720, may request a change of configuration. As an example, a base station may accordingly run multiple models, e.g. corresponding models, e.g. in parallel, and evaluate a result thereof, and/or may evaluate information received by the UE (e.g. such as an error information, e.g. an information about a quantization error) and may conclude that based on another aligned model configuration, better results may be achievable and may hence request and/or force a configuration change.

Hence, a computational load for managing a change of configuration may be shifted from device to network, e.g. from device to base station.

Accordingly, the UE may optionally determine new configurations and/or receive new configurations to be added to a set of available configurations. Configurations may be stored as look-up tables, hence reducing an indication of a respective configuration, for example, to an indication of a respective table index.

Furthermore, UE 710 may be configured to provide an information about the configuration of its model to the base station 720, in order to enable a corresponding adaptation of a corresponding model of the base station 720. As an example, the model of the UE 710 may implement a quantization functionality 714, and hence, as shown in FIG. 7, base station 720 may implement a corresponding De-quantization functionality 721.

Hence, embodiments allow aligning corresponding models in a sender-receiver setting.

### Implementation Alternatives

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

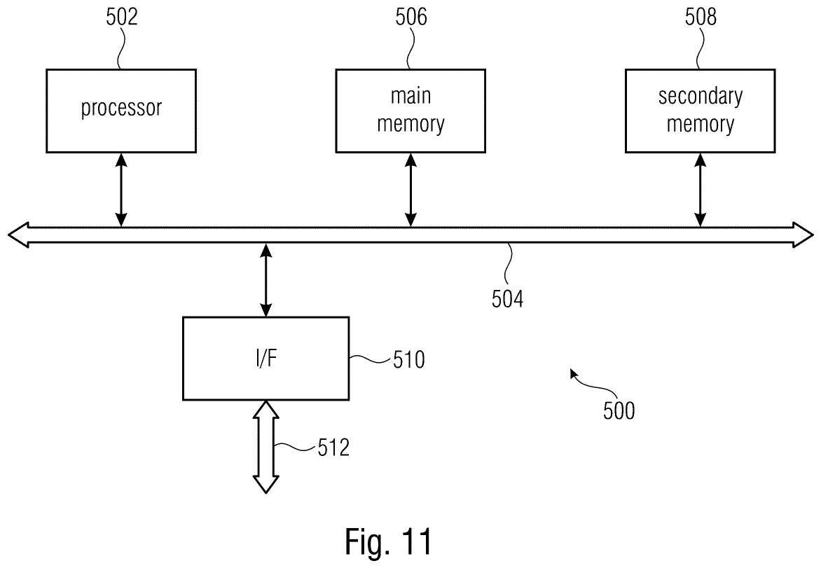

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 11 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

ABBREVIATIONS

| | |
|---|---|
| 3GPP | third generation partnership project |
| ACK | acknowledgement |
| AIM | assistance information message |
| AMF | access and mobility management function |
| BS | base station |
| BWP | bandwidth part |
| CA | carrier aggregation |
| CC | component carrier |
| CBG | code block group |
| CBR | channel busy ratio |
| CQI | channel quality indicator |
| CSI-RS | channel state information- reference signal |
| CN | core network |
| D2D | device-to-device |
| DAI | downlink assignment index |
| DCI | downlink control information |
| DL | downlink |
| DRX | discontinuous reception |
| FFT | fast Fourier transform |
| FR1 | frequency range one |
| FR2 | frequency range two |
| GMLC | gateway mobile location center |
| gNB | evolved node B (NR base station)/next generation node |
| | B base station |
| GSCN | global synchronization channel number |
| HARQ | hybrid automatic repeat request |
| ICS | initial cell search |
| IoT | internet of things |
| LCS | location services |
| LMF | location management function |
| LPP | LTE positioning protocol |
| LTE | long-term evolution |
| MAC | medium access control |
| MCR | minimum communication range |
| MCS | modulation and coding scheme |
| MIB | master information block |
| NACK | negative acknowledgement |
| NB | node B |
| NES | network energy saving |
| NR | new radio |
| NTN | non-terrestrial network |
| NW | network |
| OFDM | orthogonal frequency-division multiplexing |
| OFDMA | orthogonal frequency-division multiple access |
| PBCH | physical broadcast channel |
| P-UE | pedestrian UE; not limited to pedestrian UE, but represents |
| | any with a need to save power, e.g., electrical cars, cyclists, |
| PC5 | interface using the sidelink channel for D2D communication |
| PDCCH | physical downlink control channel |
| PDSCH | physical downlink shared channel |
| PLMN | public land mobile network |
| PPP | point-to-point protocol |
| PPP | precise point positioning |
| PRACH | physical random access channel |
| PRB | physical resource block |
| PSFCH | physical sidelink feedback channel |
| PSCCH | physical sidelink control channel |
| PSSCH | physical sidelink shared channel |
| PUCCH | physical uplink control channel |
| PUSCH | physical uplink shared channel |
| RAIM | receiver autonomous integrity monitoring |
| RAN | radio access networks |
| RAT | radio access technology |
| RB | resource block |
| RNTI | radio network temporary identifier |
| RP | resource pool |
| RRC | radio resource control |
| RS | reference symbols/signal |
| RTT | round trip time |
| SBI | service based interface |
| SCI | sidelink control information |
| SI | system information |
| SIB | sidelink information block |
| SL | sidelink |
| SPI | system presence indicator |
| SSB | synchronization signal block |
| SSR | state space representations |
| TB | transport block |
| TTI | short transmission time interval |
| TDD | time division duplex |
| TDOA | time difference of arrival |
| TIR | target integrity risk |
| TRP | transmission reception point |
| TTA | time-to-alert |
| TTI | transmission time interval |
| UCI | uplink control information |
| UE | user equipment |
| UL | uplink |
| UMTS | universal mobile telecommunication system |
| V2x | vehicle-to-everything |
| V2V | vehicle-to-vehicle |
| V2I | vehicle-to-infrastructure |
| V2P | vehicle-to-pedestrian |
| V2N | vehicle-to-network |
| V-UE | vehicular UE |
| VRU | vulnerable road user |
| WUS | wake-up signal |

1. A device for operating in a wireless communication network,
wherein the device is to operate a model to estimate and/or to predict one or more parameters and/or a characteristics of the wireless communication network.

2. The device of claim 1,
wherein the model is to map a number of parameters and/or characteristics to a number of quantized values.

3. The device of claim 2,
wherein the device is to operate the model with a configuration of a plurality of configurations; and
wherein different configurations of the model relate to different quantisation modes for quantising the parameters and/or characteristics.

4. The device of claim 3,
wherein a configuration relating to a quantization mode comprises an information about one or more of the following:
a number of quantization steps,
a distribution of quantization intervals,
a value range,
vector and/or scalar quantization modes.

5. The device of claim 3,
wherein the plurality of configurations relate to a plurality of quantization modes; and
wherein the plurality of quantization modes comprise at least one of
a scalar quantization mode;
a vector quantization mode.

6. The device of claim 5,
wherein the plurality of configurations relate to different settings of respective quantization modes.

7. The device of claim 1,
wherein the model comprises a first portion and a second portion;
wherein the device is to acquire a measurement information indicating a condition and/or parameter and/or characteristic of the wireless communication network, the measurement information comprising a first dimensionality;
wherein the device is to provide the measurement information to the first portion of the model in order to acquire a processed version of the measurement information with a reduced, second dimensionality; and
wherein the device is to provide the measurement information with the second dimensionality to the second portion of the model in order to acquire a quantized version of the second measurement information.

8. The device of claim 1,
wherein the device is to indicate and/or to receive a configuration information of the model;
wherein the configuration information comprises at least one of
an information about an upper bound of a quantization interval
an information about a lower bound of a quantization interval
an information about a granularity of the quantization
an information about additional quantization bounds and corresponding quantization step values
an information about a quantization step vector comprising a plurality of quantization step values.

9. The device of claim 8,
wherein the device is to indicate and/or to receive the configuration information or a portion thereof in the form of a look-up table and/or an information for determining the configuration information using a look-up table.

10. The device of claim 1, wherein the device is to indicate an information about a change of the model and/or of a change of a configuration of the model, such as a change of a or the configuration of the model from a or the first configuration to a or the different second configuration, in case said change was performed and/or triggered by the device based on an evaluation of a or the condition.

11. The device of claim 10,
wherein the device is to operate the model with a first configuration from a plurality of configurations;
wherein the device is to change the configuration of the model to a different second configuration; and
wherein the device is to operate the model in the second configuration;
wherein configurations of the plurality of configurations relate quantisation modes; and
wherein the device is to indicate an information about a change of the configuration of the model from the first configuration to the different second configuration, in case said change was performed and/or triggered by the device based on an evaluation of a or the condition, in order to align a quantisation configuration between the device and the wireless communication network.

12. The device of claim 1, wherein the device is to receive an indication indicating a command and/or a request to change a or the configuration of the model to another configuration and/or to operate the model in the other configuration.

13. The device of claim 1,
wherein the device is to acquire an indication comprising a configuration for the operation of the model.

14. The device of claim 1,
wherein the device is to operate the model with a configuration;
wherein the configuration relates to a quantization mode;
wherein the device is to indicate and/or to receive a quantization configuration information for the quantization mode, the quantization configuration information comprising a quantization configuration for a measurement value, a list of quantization parameters and/or an error reporting information.

15. The device of claim 14,
wherein the quantization configuration for a measurement value comprises at least one of
an index information
an information about a list of quantization parameters
an information about one or more conditions
an information about an energy level and/or an energy consumption.

16. The device of claim 14,
wherein the list of quantization parameters comprises an information about a uniform quantization, comprising at least one of
an index information
an information about a number of bits
an information about a lower bound of the quantization
an information about a size of a quantization range; and/or
wherein the list of quantization parameters comprises an information about a non-uniform quantization, comprising at least one of
an index information
an information about quantization values
an information about a lower bound of the quantization, an information about a upper bound of the quantization and an information about a quantization steps.

17. The device of claim 1,
wherein the device is to operate at least a portion of the model with a fixed configuration; and/or
wherein the device is to exchange at least a portion of the model.

18. The device of claim 1,
wherein the device is to change the configuration of the model in a training phase of the model or in a training phase of a portion of the model; and/or
wherein the device is to change the configuration of the model in an inference phase of the model during operation of the wireless communication network.

19. An entity for operating in a wireless communication network, wherein the entity is to control operation of a model at a device in the wireless communication network, the model adapted to estimate and/or to predict one or more parameters and/or a characteristics of the wireless communication network.

20. Non-transitory digital storage medium comprising a UE-signal of a wireless communication network, the UE signal comprising information for aligning a quantisation configuration between the UE and the wireless communication network.
